(19) United States
(12) Patent Application Publication
(10) Pub. No.: US 2025/0238250 A1
(43) Pub. Date: Jul. 24, 2025

(54) SYSTEMS AND METHODS FOR INDEPENDENT CONTAINER LAYER SHARING IN A DISTRIBUTED ECOSYSTEM

(71) Applicant: Dell Products L.P., Round Rock, TX (US)

(72) Inventors: Fabricio C. DUARTE, Stanwood, WA (US); Ryan N. COMER, Round Rock, TX (US); Jake M. LELAND, Round Rock, TX (US); Uboho VICTOR, San Antonio, TX (US)

(73) Assignee: Dell Products L.P., Round Rock, TX (US)

(21) Appl. No.: 18/419,214

(22) Filed: Jan. 22, 2024

(51) Int. Cl. G06F 9/455

(52) U.S. Cl. CPC G06F 9/45558; G06F 2009/45562; G06F 2009/45595

(57) ABSTRACT

An information handling system may include a processor and a container orchestrator comprising a program of instructions configured to, when read and executed by the processor, in a distributed ecosystem comprising a plurality of host systems, in connection with a build of a new container image to be stored in a container image repository associated with the distributed ecosystem: identify, based on existing container images stored in the container image repository, existing dependency layers of the existing container images for which the new container image has dependencies; identify application-specific layers of the new container image unique to the new container image; and build and store the new container image in the container image repository, the image including the application-specific layers and the dependency layers.

### TECHNICAL FIELD

The present disclosure relates in general to information handling systems, and more particularly to methods and systems for independent container layer sharing in a distributed system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In a distributed computing system, the ecosystem may have a plurality of distributed computing endpoints, each endpoint capable of instantiating containers for executing workloads. Containerization is an increasingly popular method of packaging and distributing software, with benefits in security, portability, and scalability. Workloads running in containers may be easily moved, or “offloaded,” to machines better suited for the task.

Provisioning an endpoint with a containerized application from a remote image repository incurs an upfront networking cost in terms of data usage and download time. Subsequent container updates can lessen the networking cost by leveraging cached image layers and downloading only the layers which have changed. Container technologies utilize layers in this way to optimize the performance of individual container image updates, but because layers are unique to specific container images, these benefits cannot be shared across other container images. In computing environments which make heavy use of containerized applications, excess networking cost is incurred when individual applications re-download container image layers which already exist on the local system.

### SUMMARY

In accordance with the teachings of the present disclosure, the disadvantages and problems associated with existing approaches to container placement on an endpoint of a distributed ecosystem may be reduced or eliminated.

In accordance with embodiments of the present disclosure, an information handling system may include a processor and a container orchestrator comprising a program of instructions configured to, when read and executed by the processor, in a distributed ecosystem comprising a plurality of host systems, in connection with a build of a new container image to be stored in a container image repository associated with the distributed ecosystem: identify, based on existing container images stored in the container image repository, existing dependency layers of the existing container images for which the new container image has dependencies; identify application-specific layers of the new container image unique to the new container image; and build and store the new container image in the container image repository, the image including the application-specific layers and the dependency layers.

In accordance with these and other embodiments of the present disclosure, an information handling system may include a processor and a container orchestrator comprising a program of instructions configured to, when read and executed by the processor, in a distributed ecosystem comprising a plurality of host systems, in connection with a new container image being stored in a container image repository associated with the distributed ecosystem: detect shared dependencies among a plurality of container images, including the new container image, stored in the container image repository; based on the shared dependencies, rebuild each of the plurality of container images, wherein each of the plurality of container images as rebuilt includes one or more layers unique to such container image and one or more shared layers, each shared layer shared with at least one other of the plurality of container images; and store the plurality of container images, as rebuilt, in the container image repository.

In accordance with these and other embodiments of the present disclosure, a method may include comprising, in a distributed ecosystem comprising a plurality of host systems, in connection with a build of a new container image to be stored in a container image repository associated with the distributed ecosystem: identifying, based on existing container images stored in the container image repository, existing dependency layers of the existing container images for which the new container image has dependencies; identifying application-specific layers of the new container image unique to the new container image; and building and storing the new container image in the container image repository, the image including the application-specific layers and the dependency layers.

In accordance with these and other embodiments of the present disclosure, a method may include, in a distributed ecosystem comprising a plurality of host systems, in connection with a new container image being stored in a container image repository associated with the distributed ecosystem: detecting shared dependencies among a plurality of container images, including the new container image, stored in the container image repository; based on the shared dependencies, rebuilding each of the plurality of container images, wherein each of the plurality of container images as rebuilt includes one or more layers unique to such container image and one or more shared layers, each shared layer shared with at least one other of the plurality of container images; and storing the plurality of container images, as rebuilt, in the container image repository.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example distributed ecosystem, in accordance with embodiments of the present disclosure;

FIG. 2 illustrates a block diagram demonstrating an example method for build-time image creation, in accordance with embodiments of the present disclosure; and

FIG. 3 illustrates a block diagram demonstrating an example method for post-build image creation, in accordance with embodiments of the present disclosure.

### DETAILED DESCRIPTION

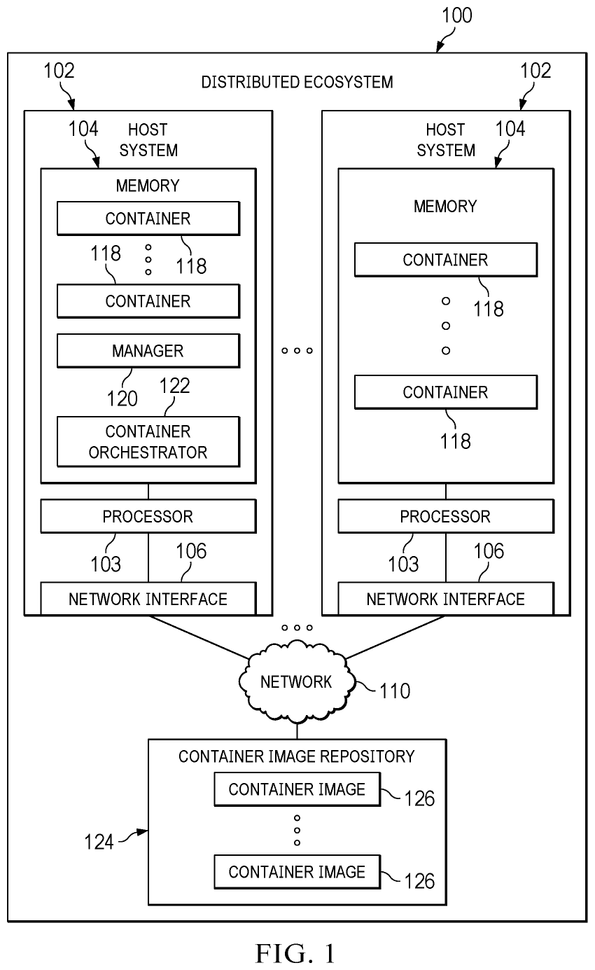

Preferred embodiments and their advantages are best understood by reference to FIGS. 1 through 3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of selected components of an example distributed ecosystem 100 having a plurality of host systems 102, in accordance with embodiments of the present disclosure. As shown in FIG. 1, distributed ecosystem 100 may include a plurality of host systems 102 coupled to one another via a network 110. In some embodiments, two or more of the plurality of host systems 102 may be co-located in the same geographic location (e.g., building or data center). In these and other embodiments, two or more of the plurality of host systems 102 may be co-located in the enclosure, rack, or chassis. In these and other embodiments, two or more of the plurality of host systems 102 may be located in substantially different geographic locations.

A host system 102 may comprise an information handling system. In some embodiments, a host system 102 may comprise a server (e.g., embodied in a “sled” form factor). In these and other embodiments, a host system 102 may comprise a personal computer. In other embodiments, a host system 102 may be a portable computing device (e.g., a laptop, notebook, tablet, handheld, smart phone, personal digital assistant, etc.). As depicted in FIG. 1, host system 102 may include a processor 103, a memory 104 communicatively coupled to processor 103, and a network interface 106 communicatively coupled to processor 103. For the purposes of clarity and exposition, in FIG. 1, each host system 102 is shown as comprising only a single processor 103, single memory 104, and single network interface 106. However, a host system 102 may comprise any suitable number of processors 103, memories 104, and network interfaces 106.

As used herein, a host system 102 may sometimes be referred to herein as an “endpoint” of distributed ecosystem 100.

A processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in a memory 104 and/or other computer-readable media accessible to processor 103.

A memory 104 may be communicatively coupled to a processor 103 and may include any system, device, or apparatus configured to retain program instructions and/or data for a period of time (e.g., computer-readable media). A memory 104 may include RAM, EEPROM, a PCMCIA card, flash memory, magnetic storage, opto-magnetic storage, or any suitable selection and/or array of volatile or non-volatile memory that retains data after power to host system 102 is turned off.

As shown in FIG. 1, a memory 104 may have stored thereon one or more containers 118. In some embodiments, one or more of containers 118 may be stored in a computer-readable medium (e.g., a local or remote hard disk drive) other than a memory 104 which is accessible to processor 103.

A container 118 or containerized application may include instructions for a container runtime to virtualize a computer's operating system kernel, enabling users to install containers (e.g., isolated application environments) on a virtualized operating system. Containerized applications may be built based on a containerfile, which is an ordered list of instructions on how to set up an environment and install an application. Each command in such ordered list may become a subsequent layer in the final container image. Often, the first few instructions in this containerfile will install libraries that the application needs to run, forming layers that are effectively “independent” and thus good candidates for sharing across other container images.

At least one host system 102 in distributed ecosystem 100 may have stored within its memory 104 a manager 120. A manager 120 may comprise software and/or firmware generally operable to manage containers 118 instantiated on each host system 102, including controlling migration of containers between host systems 102.

At least one host system 102 in distributed ecosystem 100 may have stored within its memory 104 a container orchestrator 122. As described in greater detail below, container orchestrator 122 may comprise software and/or firmware generally operable to orchestrate the build of container images which may be used in distributed ecosystem 100. To that end, container orchestrator 122 may analyze container build files to identify independent instructions (e.g., package install commands) which may be built into independent layers. Accordingly, container orchestrator 122 may cause all container images dependent on such instructions to be updated to reference shared layers. Thus, upon further provisioning or updating of container images, network costs may be reduced by leveraging local caching for existing shared layers.

A network interface 106 may include any suitable system, apparatus, or device operable to serve as an interface between an associated host system 102 and network 110. A network interface 106 may enable its associated host system 102 to communicate with network 110 using any suitable transmission protocol (e.g., TCP/IP) and/or standard (e.g., IEEE 802.11, Wi-Fi). In certain embodiments, a network interface 106 may include a physical NIC. In the same or alternative embodiments, a network interface 106 may be configured to communicate via wireless transmissions. In the same or alternative embodiments, a network interface 106 may provide physical access to a networking medium and/or provide a low-level addressing system (e.g., through the use of Media Access Control addresses). In some embodiments, a network interface 106 may be implemented as a local area network (“LAN”) on motherboard (“LOM”) interface. A network interface 106 may comprise one or more suitable network interface cards, including without limitation, mezzanine cards, network daughter cards, etc.

Network 110 may be a network and/or fabric configured to communicatively couple information handling systems to each other. In certain embodiments, network 110 may include a communication infrastructure, which provides physical connections, and a management layer, which organizes the physical connections of host systems 102 and other devices coupled to network 110. Network 110 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 110 may transmit data using any storage and/or communication protocol, including without limitation, Fibre Channel, Fibre Channel over Ethernet (FCOE), Small Computer System Interface (SCSI), Internet SCSI (iSCSI), Frame Relay, Ethernet Asynchronous Transfer Mode (ATM), Internet protocol (IP), or other packet-based protocol, and/or any combination thereof. Network 110 and its various components may be implemented using hardware, software, or any combination thereof.

In addition to processor 103, memory 104, and network interface 106, a host system 102 may include one or more other information handling resources.

As shown in FIG. 1, distributed ecosystem 100 may also include a container image repository 124 communicatively coupled to network 110. Container image repository 124 may include a repository of container images that may be instantiated as containers 118 on host systems 102, including the various software layers that may make up each of such container images. Accordingly, container registry 124 may be used by container orchestrator 122 to store container images 126 including shared layers between or among container images 126. In some embodiments, container image repository 124 may reside on a host system 102 of distributed ecosystem 100.

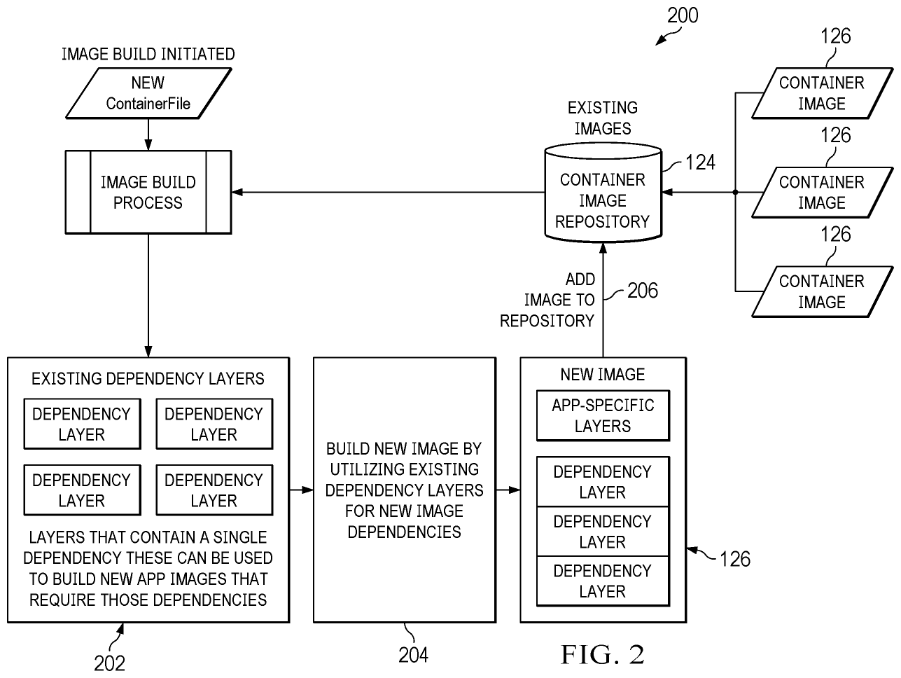

FIG. 2 illustrates a block diagram demonstrating an example method 200 for build-time image creation, in accordance with embodiments of the present disclosure. According to some embodiments, method 200 may begin at step 202 and may be implemented in a variety of configurations of distributed ecosystem 100. As such, the preferred initialization point for method 200 and the order of the steps comprising method 200 may depend on the implementation chosen.

At step 202, an image build process implemented within container orchestrator 122 may, for a new container file, identify existing dependency layers within the new container file based on layers present within container images 126 of container image repository 124. Dependency layers may comprise layers that contain a single dependency within the new container file to a layer present in a container image 126 stored within container image repository 124.

At step 204, the image build process may build a new container image 126 for the new container file utilizing the existing image layers for new image dependencies. As shown in FIG. 2, such new container image 126 may include one or more application-specific layers (e.g., layers uniquely specific to the new container image) and one or more dependency layers shared with another container image 126.

At step 206, the image build process may store the new container image 126 to container image repository 124. After completion of step 206, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using distributed ecosystem 100 or any other system operable to implement method 200. In certain embodiments, method 200 may be implemented partially or fully in software and/or firmware embodied in computer-readable media.

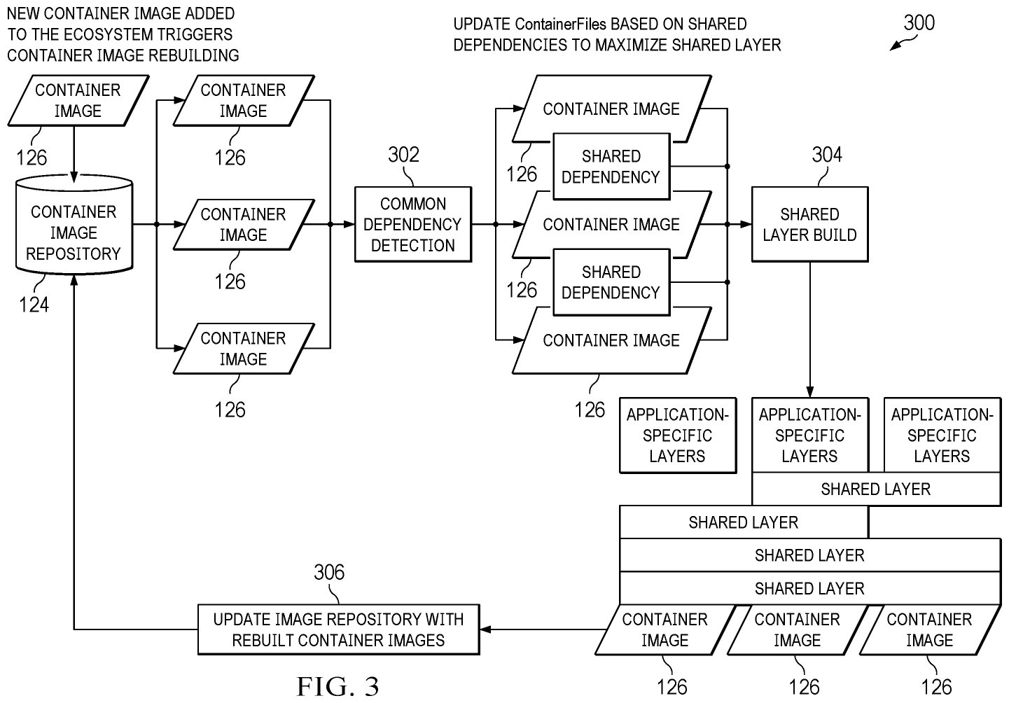

FIG. 3 illustrates a block diagram demonstrating an example method 300 for post-build image creation, in accordance with embodiments of the present disclosure. According to some embodiments, method 300 may begin at step 302 and may be implemented in a variety of configurations of distributed ecosystem 100. As such, the preferred initialization point for method 300 and the order of the steps comprising method 300 may depend on the implementation chosen.

At step 302, container orchestrator 122 may, responsive to a new container image 126 being added to container image repository 124, determine shared dependencies among two or more container images 126. At step 304, container orchestrator 122 may, based on the shared dependencies, rebuild each of the container images, including application-specific layers for each container image 126 and one or more shared layers with each container image 126 shared with at least one other container image 126, thus maximizing shared layers among container images 126.

At step 306, container orchestrator 122 may update container image repository 124 with the rebuilt container images 126. After completion of step 306, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using distributed ecosystem 100 or any other system operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale. All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor; and
a container orchestrator comprising a program of instructions configured to, when read and executed by the processor, in a distributed ecosystem comprising a plurality of host systems, in connection with a build of a new container image to be stored in a container image repository associated with the distributed ecosystem:
identify, based on existing container images stored in the container image repository, existing dependency layers of the existing container images for which the new container image has dependencies;
identify application-specific layers of the new container image unique to the new container image; and
build and store the new container image in the container image repository, the image including the application-specific layers and the dependency layers.

2. An information handling system comprising:
a processor; and
a container orchestrator comprising a program of instructions configured to, when read and executed by the processor, in a distributed ecosystem comprising a plurality of host systems, in connection with a new container image being stored in a container image repository associated with the distributed ecosystem:
detect shared dependencies among a plurality of container images, including the new container image, stored in the container image repository;
based on the shared dependencies, rebuild each of the plurality of container images, wherein each of the plurality of container images as rebuilt includes:
one or more layers unique to such container image; and
one or more shared layers, each shared layer shared with at least one other of the plurality of container images; and
store the plurality of container images, as rebuilt, in the container image repository.

3. A method comprising, in a distributed ecosystem comprising a plurality of host systems, in connection with a build of a new container image to be stored in a container image repository associated with the distributed ecosystem:
identifying, based on existing container images stored in the container image repository, existing dependency layers of the existing container images for which the new container image has dependencies;
identifying application-specific layers of the new container image unique to the new container image; and
building and storing the new container image in the container image repository, the image including the application-specific layers and the dependency layers.

4. A method comprising, in a distributed ecosystem comprising a plurality of host systems, in connection with a new container image being stored in a container image repository associated with the distributed ecosystem:
detecting shared dependencies among a plurality of container images, including the new container image, stored in the container image repository;
based on the shared dependencies, rebuilding each of the plurality of container images, wherein each of the plurality of container images as rebuilt includes:
one or more layers unique to such container image; and
one or more shared layers, each shared layer shared with at least one other of the plurality of container images; and
storing the plurality of container images, as rebuilt, in the container image repository.
